(19) United States
(12) Patent Application Publication
(10) Pub. No.: US 2023/0263701 A1
(43) Pub. Date: Aug. 24, 2023

(54) DEVICE AND METHOD FOR THE NON-INVASIVE PERSONALIZED TREATMENT OF SKIN BLEMISHES

(71) Applicant: FENIX GROUP S.R.L., Montesilvano (PE) (IT)

(72) Inventor: Gianluca CAVALLETTI, Montesilvano (PE) (IT)

(21) Appl. No.: 18/004,275

(22) PCT Filed: Jul. 10, 2020
(86) PCT No.: PCT/IB2020/056521

§ 371 Date: Jan. 4, 2023

(51) Int. Cl. A61H 15/00; A61H 15/02

(52) U.S. Cl. CPC A61H 15/0085; A61H 15/02; A61H 2207/00; A61H 2015/0042; A61H 2201/5082; A61H 2201/5043

(57) ABSTRACT

Device for non-invasive personalized treatment of skin disorders and imperfections, including: a console having recesses suitable for housing handpieces capable of being grasped by an operator to treat a patient's body or face thanks to the vibration generated by an internal cylinder at each handpiece at a predetermined frequency, each cylinder having rotating elements; a vibration adjustment device for each handpiece; an electric energy absorption sensor possibly combined with pressure and/or rpm sensors for each handpiece, suitable for communicating the data detected to a control unit adapted to process the data from the absorption sensors and to act on the frequency regulation devices of each handpiece to obtain an immediate variation of the vibration of the cylinders according to the mechanical resistance offered by the patient's tissue; and a communication interface.

### FIELD OF THE INVENTION

The present invention relates the field of aesthetic, sports and rehabilitation medicine, in particular it describes a device capable of recognizing and treating, through compressive micro-vibration, certain pathologies such as cellulite, tissue recompaction, lymphatic and venous stasis, edematosis, muscle and scar contractures, shoulder-neck syndrome and pubalgia. Other fields of application of this device are the treatments aimed at athletes before and after surgery, sports massage, lymphatic drainage and the treatment of pains of different origin.

### Prior Art

The so-called cellulite, also called “gynoid lipodystrophy”, “edematous fibrous panniculopathy”, “edematous adiposis”, “edematous-fibro-sclerotic panniculopathy”, “dermopanniculosis deformans”, “status protrusus cutis”, and “liposclerosis”, is a topographical manifestation of the skin associated with depressions or introflexions, frequent in the pelvic and abdominal area, in the hips, buttocks and thighs. It can also occur associated with nodules in the subcutaneous adipose tissue and, in more rare cases, with a suspected inflammatory state.

The great confusion about the name to be given to cellulite reflects the difficulty of correctly understanding the nature of the phenomenon. Despite the great interest in treating this condition and the huge market for topical treatments aimed at improving its appearance, cellulite is still an enigmatic condition for medical researchers.

The high incidence (80-90/o) in the female population that presents the imperfections due to cellulite in the post-pubertal age, in addition to the fact that it occurs without symptoms, make it considered a normal physiological condition. It can instead be considered within a pathological scenario noting that it is a normal condition for many, but not all, women, and that in its most severe forms it manifests itself with painful nodules on palpation that make assume inflammatory processes, it is also generally associated with an excessive accumulation of subcutaneous adipose tissue whose relationship with cardiovascular risk is unclear.

Dozens of different causes have been hypothesized such as: metabolic disorders, nutritional disorders, specific subcutaneous architectures, changes in the structure of the connective tissue, hormonal factors, genetic factors, disorders of the microcirculatory system, changes in the lymphatic system, changes in the extracellular matrix, inflammations.

The classifications of cellulite are as follows:
edematous: that is associated with an accumulation of fluids, especially around the ankles, calves, thighs and arms.
fibrous: that is associated with an increase in trabecular structures and connective tissue septa that divide the subcutaneous adipose tissue into different lobes; fibrous cellulite is characterized by small nodules non perceived to the touch except as subcutaneous roughness and orange-peel skin.
sclerotic: that is associated with a hardening of the tissues associated with large nodules and plaques; this form can be very painful.

Several measures can help prevent cellulite. Some attention to nutrition, constant physical activity, the use of comfortable and not too tight clothes, shoes with not excessively high heels and changes in posture are the easiest remedies to implement to prevent this annoying disturbance.

In the huge market for treatments to reduce cellulite, there is a range from topical products to liposuction, although many of these treatments lack evidence of efficacy. The most common are listed:
topical products or creams and the like to be applied manually on the affected area constantly and with daily frequency for long periods of time;
massage,
pressure therapy: treatment based on the external pressure of the patient's limbs or abdominal area through specific equipment;
mesotherapy: technique of administration of drugs by intraepidermal, superficial and deep intradermal and subcutaneous or hypodermic route, has the advantages of being able to use reduced doses of the active principle which have a prolonged effect over time;
emulsiolipolysis: a drug therapy achievable by district injection with hypothalamic phospholipids, carnitine, aminophylline, lidocaine 2%, physiological solution;
lipoapoptosis: a drug therapy achievable by district injection with vitamin C, trivalent iron, lidocaine 2%, water for injections;
carboxytherapy: treatment that originates from thermal medicine and consists in the administration of carbon dioxide subcutaneously;
osmotic lipoclasia: skin biostimulation with platelet rich plasma;
oxygenoclasia: technique of introducing pure medical oxygen through a small needle into excess fat;
endermology system: technique designed in France in the 1970s in which a vacuum system and a plurality of rollers, mounted on a handpiece, exert pressure and lifting on the skin resulting in a redistribution of subcutaneous fat.
ultrasound therapy: treatment based on the effect produced by mechanical vibrations applied on the external tissues of the body through an ultrasonic transducer.
laser therapy: treatment that acts at various depth levels based on the power of the rays transmitted.
diathermy: a practice, devoid of scientific validation, which supports healing properties induced by the increase in the temperature of some non-superficial areas of the body caused by the passage of electric current.

As can be seen from the list above, which is not exhaustive, the market is saturated with treatments, among which some are present without certain results. The ineffectiveness is often due to the fact that, as explained above, the cause of cellulite and the conditions it entails is uncertain.

There are also several patents which claim treatments for the treatment of cellulite such as US 2002147467 which provides first an exfoliating treatment to maximize the absorption of the substances applied on the skin, then the administration of mechanical vibrations associated with electrical pulsations in the affected area.

EP 1844750, on the other hand, claims an instrument for aesthetic treatments, therefore not of a medical nature, which reduces cellulite through ultrasound vibrations with a frequency between 25 kHz and 50 kHz.

GB 2303552 describes a medical apparatus capable of reducing cellulite through ultrasound at a frequency of approximately 3.3 MHz which reaches a depth of 1.27-2.54 cm from the surface of the skin without overheating the part.

The patent, extended worldwide, WO2007122656, owned by Fenix Sri, a market leader in the sector of anti-cellulite and anti-blemish therapies and skin disorders in general, claims a computer-controlled vibratory device, used to treat parts of the body, whose primary feature is to apply massages by inducing mechanical oscillations by means of a plurality of massage elements which are rotatably mounted around their axis in a roller driven by an electric motor. The rotation of the roller around its shaft is controlled by the operator through an electronic control unit, selecting a program suitable for the treatment to be performed. The device described in this patent performs a massage based on the resistance opposed by the muscles located under the fat layer.

The purpose of the present invention is to propose a device and a method of personalized compressive micro-vibration on the conditions suffered by each patient which performs four actions in a synergistic way acting on the vascular system at the level of the microcirculation, on the lymphatic system, on tissue recompaction and on the analgesic effect, also resulting in a muscular effect. The operation of this device relies on a sensor capable of detecting the type of disturbance and a dedicated software that determines the best therapy to follow on a case-by-case basis.

### DESCRIPTION OF THE INVENTION

According to the present invention, a device is provided and a method of use thereof is described for the diagnosis and non-invasive treatment of blemishes and skin disorders according to personalized methods for each patient.

The device comprises a transportable console provided with at least a pair of recesses, possibly heated by a resistance inside the recess which, operating with infrared light, also has a bactericidal function, which are configured to each house a corresponding handpiece.

The handpieces are the tool through which an operator performs treatment on a patient's skin tissues.

Advantageously, the presence of at least one larger handpiece, larger in size, suitable for carrying out the treatment on the body is provided, while the smaller handpiece, smaller in size, is specifically configured for the treatment of the face or other anatomical parts with an articulated conformation.

Each handpiece comprises a rotating cylinder on whose external surface a plurality of rotating elements independent of each other are movably connected.

In some preferred embodiments, the rotating elements of the larger handpiece are spheres, ovoids or cylinders, arranged as a honeycomb, made of gel with a hardness between 5 shore and 100 shore, preferably 35 shore. The rotating elements of the smaller handpiece, on the other hand, are spheres, ovoids or cylinders, arranged in a “V” shape, made of hypoallergenic silicone with a surface treatment suitable for obtaining a predetermined surface roughness. The roughness has the purpose of obtaining a peeling and stretching effect on the patient's skin.

The preferred embodiment of the smaller handpiece, i.e. the one dedicated to facial treatments, provides that the rotating elements of the cylinder are arranged so as to impart a converging or diverging force with respect to the center line of the cylinder itself which constitutes the neutral point. Right at this point, advantageously, a ring nut is provided which, rotating around the longitudinal axis of said cylinder, is adapted to modify the angle of incidence of said rotating elements, or to cause them to compress or dilate the patient's skin. This feature has evident wrinkle smoothing effects, with efficacy comparable to injections of hyaluronic acid or botulinum, but obtaining the same advantageous result without infiltrations, injections or other invasive interventions.

The rotating elements of the larger handpiece, on the other hand, in an even more advantageous embodiment, have an external surface provided with a plurality of recesses in the shape of a spherical cap able to create a suction effect when pressed onto the patient's skin. In other words, they have a “golf ball” geometry. When the recesses are pressed against the patient's skin, they adhere to it thanks to the sucker effect due precisely to the geometry of the rotating elements. When the cylinder, by rotating, causes the recesses attached sucker-like to the patient's skin to detach, a sucking of the tissues is generated which has beneficial effects on the treatment of the blemishes associated with the conditions that cause cellulite. Advantageously, the treatment is performed thanks to the simultaneity of rotation, vibration and the pressure that the operator imparts perpendicularly on the patient's tissues, compressing them.

The pressure is regulated by the experience of the operator, or, in a more equipped version of the present invention, by an indicator light placed on the handle of the handpieces on the side in view of the operator when in action. Said light signaler consists of a plurality of LED lights adapted to be progressively turned on with the increase of the pressure exerted by the operator on the body of the patient and vice versa.

The rotation and vibration frequency is regulated by the operator through the communication interface, preferably integrated in the console and possibly also replicated on the back of the handpieces, which acts on a rotation and vibration adjustment device integrated in each handpiece.

Optionally, it will be possible to independently adjust the rotation frequency and the vibration frequency of the handpiece cylinders.

The method of using the device involves the following steps:
(A) first step of parameter setting, in which the operator sets, through the communication interface, an admissible range of frequency of vibrations based on the features of the patient's tissue, his/her age and his/her musculature. The frequency of vibrations is always between 20 Hz and 700 Hz, preferably between 40 Hz and 355 Hz;
(B) second test step, in which, by grasping the handle of the handpiece dedicated to the region to be treated (larger handpiece if on the body, smaller handpiece if on the face), the operator extracts it from the relative recess of the console and places it with the cylinder in contact with the skin tissue to be treated. An electrical energy absorption sensor, possibly combined with pressure and/or rpm sensors, with which both handpieces are advantageously provided, sends the detected data to a control unit integrated in the treatment device. By comparing the electricity absorption data and the rotation and vibration frequency data set by the operator, the control unit communicates, via the communication interface, the correctness or otherwise of the frequency range of the rotations and vibrations set by said operator. For example, if the cylinder absorbs an amount of electricity exceeding a certain preset threshold, it means that the frequency range set by the operator is too low for the features of the patient's skin tissue. Evidently the operator's evaluation was incorrect. At this point the communication interface will signal the operator that the frequency range of rotations and vibrations is different or unsuitable for the condition of the disturbance detected by the device on the patient's body, also indicating the recommended value.
(C) Third step of administration of the treatment, in which said operator covers the areas of the patient's body or face to be treated with the selected handpiece, applying a predetermined pressure perpendicular to the patient's skin tissue. During the third step of administration of the therapy, if the electric energy absorption sensor, possibly combined with pressure and/or rpm sensors, of the handpiece in use should detect an area of greater mechanical strength, for example a muscle contracture, the control unit that processes the data sent by said electric energy absorption sensor, sends a command to increase the frequency of rotation and vibrations to a device for adjusting the frequency of the handpiece in use, until a lower mechanical resistance is detected.
(D) fourth step of checking the homogeneity of the treatment on the whole area affected by the condition or skin imperfection. In the simpler version of the treatment device, this last step is performed through the visual analysis, by the operator, of the redness of the skin due to the vascularization of the tissue induced by the treatment.
Alternatively, the fourth checking step can advantageously be performed in a more scientific way. In this case, the device advantageously also includes a temperature sensor on each handpiece, suitable for detecting the patient's skin temperature, sending the data to said control unit which reproduces the data on said communication interface, also indicating the value of the increase of temperature since the beginning of the treatment. In this way, a constant increase corresponds to the homogeneity of the treatment that the operator can control based on certain scientific data.

Even more advantageous embodiments of the handpieces provide for the provision on them of at least one of the following accessories:
a common quick release mechanism designed to allow stable disconnection and re-connection between a handpiece and the relative cylinder and therefore allow total sanitation between treatments;
a pair of lateral indicators, placed on both sides of the relative handpiece, adapted to emit light signals to the operator in order to indicate the drain direction for the purposes of a correct lymphatic drainage;
a display adapted to replicate said communication interface on the side of the handpiece viewed by the operator;
an internal resistance capable of raising its temperature, when unused, up to a predetermined temperature that can be set via said communication interface;
the oversized handle to make the handpiece ergonomically more comfortable to grip.

The advantages of the present invention are clear in the light of the foregoing description and will be even more so thanks to the accompanying figures and to the description of the preferred embodiment.

### DESCRIPTION OF THE FIGURES

The invention will hereinafter be described in at least one preferred embodiment thereof by way of non-limiting example with the aid of the accompanying figures, in which:

FIG. 1 shows a general view of the console 1 with the two recesses 1.1-1.2 for the two handpieces 3-4, the communication interface 2 and the control unit 5 schematized inside the body of the console 1.

FIG. 2 shows in detail the external structure of the two handpieces 3-4 with all the features that allow the operator performing the treatment not to make mistakes and to act effortlessly. FIG. 2(a) shows a lateral view, while FIG. 2(b) shows the front view, i.e. the side of the handpiece 3-4 that is in view of the operator while he/she is performing the treatment on the patient's body or face.

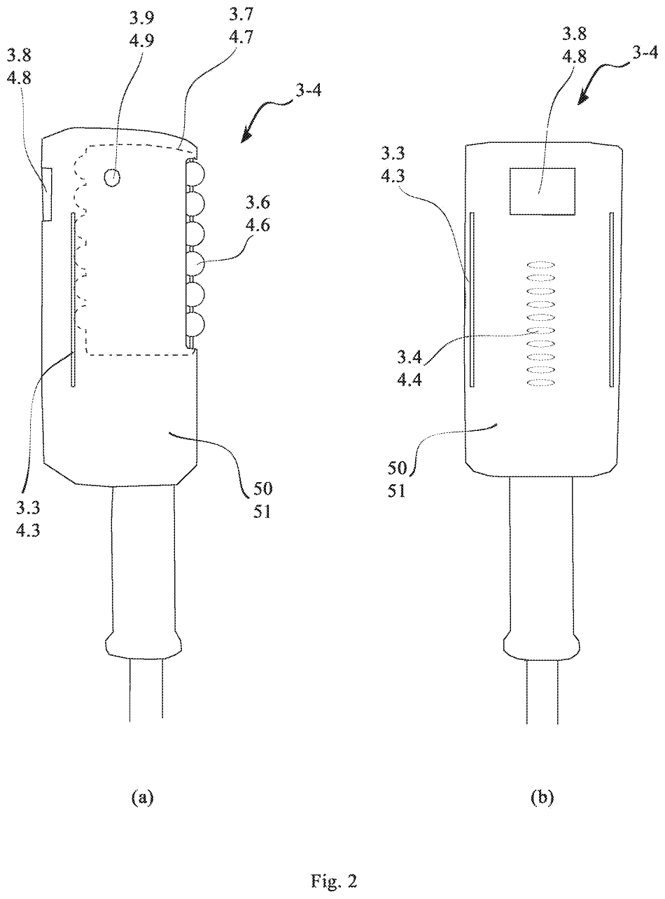

FIG. 3 shows the arrangement of the spheres on the two handpieces 3-4. FIG. 3(a) shows the honeycomb arrangement of the spheres 3.6 of the cylinder 3.7 of the first handpiece 3. FIG. 3(b), on the other hand, shows the arrangement of the spheres 4.6 of the cylinder 4.7 of the second handpiece 4 provided with a ring nut 4.7.1.

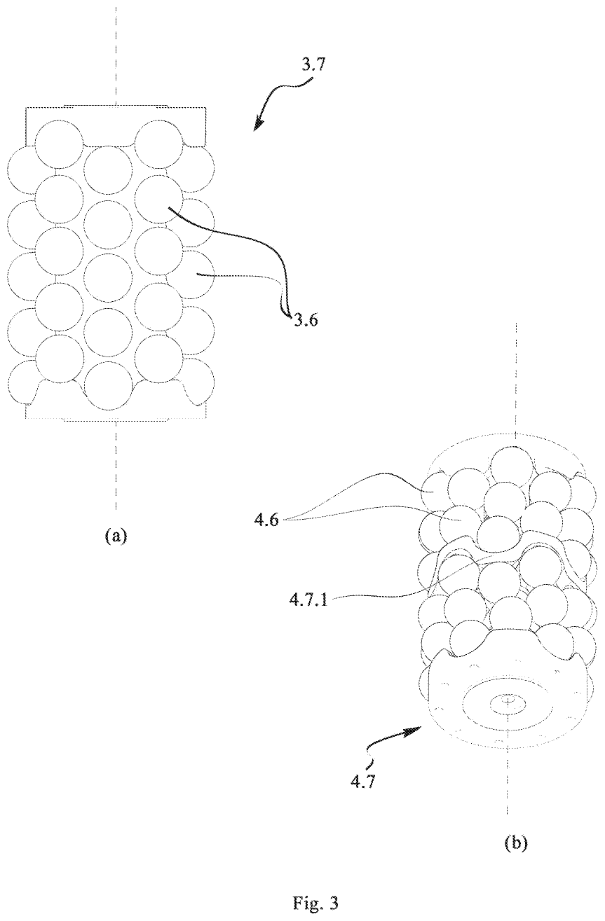

FIG. 4 schematically shows the relationship between the electric energy absorption sensors 3.1-4.1 of the two handpieces 3-4 which communicate the data detected to the control unit 5 which, in turn, acts on the relative frequency regulation devices.

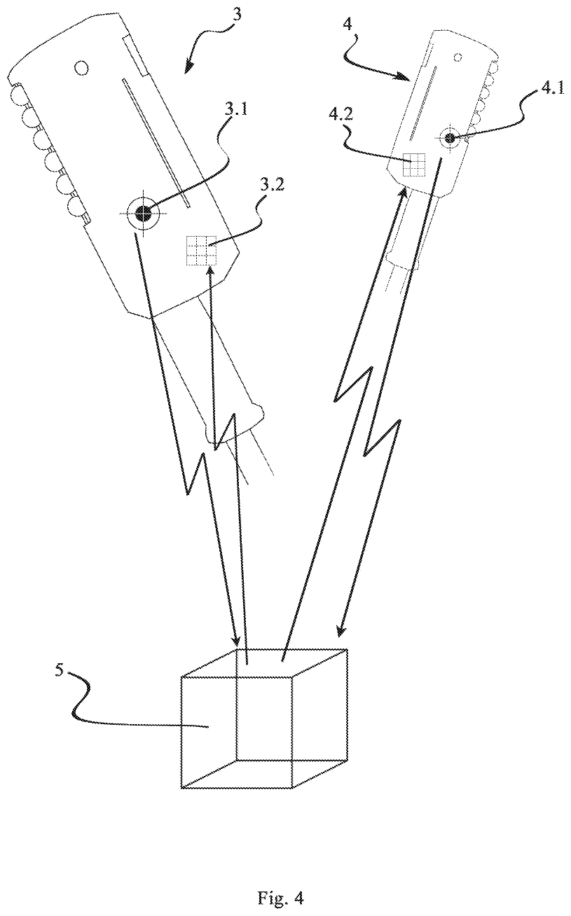

### DETAILED DESCRIPTION OF THE INVENTION

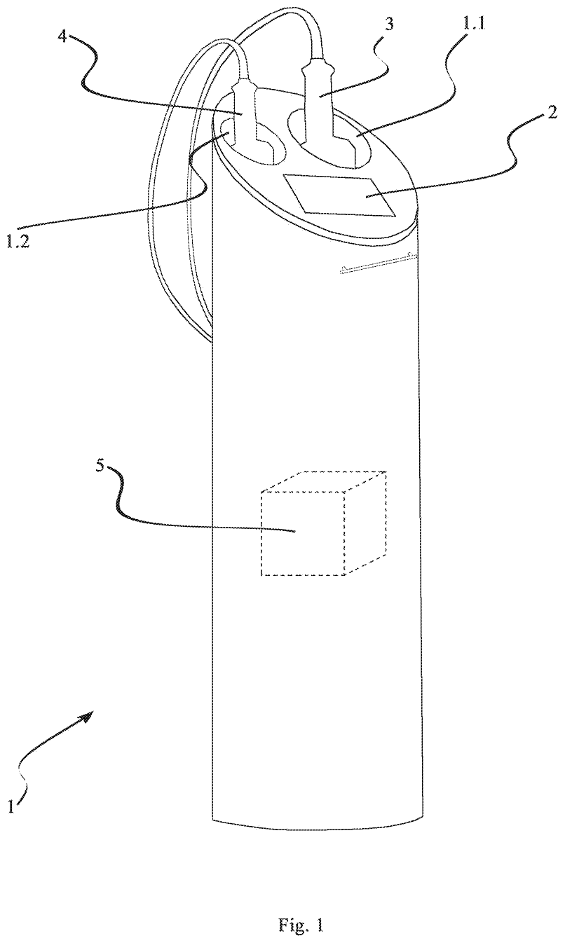

With reference to FIG. 1, the personalized and non-invasive treatment device of the present invention is shown in a three-dimensional view.

It is provided with a console 1 provided with wheels and handles for easy transport and with electrical connection means for powering the integrated components. At the top, said console 1 is provided with a pair of recesses 1.1-1.2 of which one suitable for housing a larger handpiece 3 and a smaller one suitable for housing a smaller handpiece 4.

The difference in size between the handpieces 3-4 is due to several factors, but mainly to the fact that the larger handpiece 3 is specifically designed to perform treatments on larger areas of the patient's body, while the smaller handpiece 4 is suitable for being applied on the face or on other anatomical parts with an articulated conformation.

Both said handpieces 3-4 contain a relative cylinder 3.7-4.7 which rotates and turns, at predetermined frequencies. On the external surface of each cylinder 3.7-4.7, independent rotating spheres 3.64.6 are movably engaged.

Another difference between the handpieces 3-4 is represented by the type of said spheres 3.6-4.6. Both types of spheres have a hardness between 5 shore and 100 shore, preferably 35 shore, but, while the spheres 3.6 of the larger handpiece 3 are made of gel and are arranged as a honeycomb, the spheres 4.6 of the smaller handpiece 4 are made of silicone, they are arranged in a “V” shape and have a surface finish that makes them rough so as to perform a peeling and stretching of the patient's face skin.

Finally, the smaller handpiece 4 is characterized in that the spheres 4.6 which are located in the upper portion of the cylinder 4.7 rotate in the opposite direction to the spheres 4.6 located in the lower portion of the cylinder 4.7. This means that, with respect to a neutral point, towards which the thrust of the spheres 4.6 converges or from which it diverges, a relaxing or recompacting effect of the skin tissue is obtained. Just at this neutral point there is a ring nut 4.7.1 which, if rotated by the operator acting on the handpiece 4, changes the rotation angle of the spheres 4.6, thus obtaining the converging or diverging effect.

The operation of the device object of the present invention is semi-automatic in that it makes use of advanced software capable of setting the treatment parameters in real time, following any change in the mechanical features of the skin tissue undergoing treatment.

This is made possible by the fact that each handpiece 3-4 is provided with an electrical energy absorption sensor 3.1-4.1, possibly combined with pressure and/or rpm sensors, which detects the amount of electrical energy absorbed by the relative handpiece 3-4 to obtain the desired rotation and vibration frequency. This absorption varies according to the mechanical resistance of the patient's skin tissue. Said sensors 3.1-4.1 send the detected data to a control unit 5 programmed with the aforementioned software which processes them and verifies that the resistance the desired rotation and vibration frequency is not excessive or too mild for the mechanical resistance of the tissue on which said handpiece 3-4 acts.

To regulate in real time the frequency of this rotation and of this vibration, the control unit 5 acts on a device for adjusting the rotation and vibration 3.2-4.2 integrated in each of said handpieces 3-4.

Let's assume now that we need to perform a relaxing treatment on the back of a patient, let's put a sportsman, suffering from muscle contractures.

The operator first performs a parameter setting step, selecting a frequency range of rotations and vibrations (always between a minimum of 20 Hz, preferably 40 Hz and a maximum of 700 Hz, preferably 355 Hz). The range is set through a specific communication interface 2, integrated in said console 1. The operator, based on his/her experience, selects the frequency according to age, musculature and the condition suffered. In the example in question this will be quite high.

At this point, a second test step follows in which, by grasping the larger handpiece 3 and placing its cylinder 3.7 in contact with a point on the patient's back, the electrical energy absorption sensor 3.1, possibly combined with pressure and/or rpm sensors, of the larger handpiece 3 sends the detected data to the control unit 5. From the latter, by comparing the electricity absorption data and the rotation and vibration frequency data set by the operator, the control unit communicates, via the communication interface, the correctness or otherwise of the frequency range of the rotations and vibrations set by the operator.

Treatment can now be administered in the third step of the treatment method. In this step, the operator runs across the patient's back with the larger handpiece 3, applying a predetermined pressure perpendicular to the patient's skin tissue. The applied pressure force is communicated to the operator by a light signaler 3.4 constituted by a plurality of LED lights adapted to be progressively turned on with the increase of the pressure exerted by the operator on the body of the patient and vice versa.

During this third step of administration of the therapy, if the electric energy absorption sensor 3.1 should detect an area of greater mechanical strength typically due to a muscle contracture, the control unit 5 that processes the data sent by said electric energy absorption sensor 3.1, sends a command to increase the frequency of rotations and vibrations to the device 3.2 for adjusting the frequency of the larger handpiece 3, until a lower mechanical resistance is detected.

The therapy causes the vascularization of the tissues and therefore the raising of their temperature and the consequent redness. Thanks to the visual analysis of the patient's back, the operator can check the homogeneity of the therapy on the whole part to be treated.

At the end of the treatment, thanks to a quick release mechanism 3.9 located laterally to the handle 50 of the handpiece 3, the cylinder 3.7 inside the handpiece 3 can be disconnected so as to be able to extract the cylinder 3.7 and sanitize it in all its parts, spheres 3.6 included.

Finally, it is clear that modifications, additions or variants may be made to the invention described thus far which are obvious to a man skilled in the art, without departing from the scope of protection that is provided by the appended claims.

1. Device for the non-invasive personalized treatment of skin blemishes and disturbances, adapted for the diagnosis and treatment of skin blemishes and disturbances based on the characteristics of each patient, the device comprising:
a console provided with wheels and handles for an easy transport and electrical connection means for the power supply of the components integrated in the console itself, comprising at least one pair of recesses adapted to reversibly house a corresponding pair of handpieces;
said at least one pair of handpieces including a larger handpiece and a smaller handpiece; said larger handpiece being adapted to be grasped on grip thereof by an operator for performing the micro-vibration treatment on the body of a patient; said smaller handpiece being adapted to be grasped on a grip thereof by an operator in order perform micro-vibration treatment on the face of a patient; said treatment being administered due to the rotation and to the simultaneous vibration of each internal cylinder relative to each handpiece which rotates and vibrates at a pre-established frequency; each of said cylinders being provided, on its external surface, with a plurality of independently movable rotary elements connected to said cylinder, adapted to be pressed on the body or on the face of the patient, in order to obtain the desired massaging effect;
at least one device for adjusting the rotation and vibration, integrated in each handpiece, and adapted to govern the frequency of said rotations and vibrations of said cylinder of said handpieces;
at least one electrical energy absorption sensor for each handpiece, adapted to detect the quantity of electrical energy absorbed by each handpiece in order to obtain the rotation and the vibration that are desired for the relative rotating elements; said electrical energy absorption sensors being adapted to communicate the data relative to
a control unit programmed with a dedicated software adapted to process the data coming from said electrical energy absorption sensors and consequently act, in real time, on said frequency adjusting devices of each handpiece in order to obtain an immediate variation of the rotation and vibration frequency of said cylinders, within a pre-established range comprised between 20 Hz and 700 Hz, preferably between 40 Hz and 355 Hz, depending on the mechanical strength offered by the skin tissue of the patient in contact with one of said handpieces; and
a communication interface, preferably integrated in said console, adapted to allow an operator to receive, in real time, the information regarding the treatment underway and to set the desired parameters between which the frequency of the vibrations and of the rotations to be administered to the patient through said handpieces.

2. Device for the non-invasive personalized treatment of skin blemishes and disturbances, according to claim 1, wherein said rotating elements of said cylinder integrated in said larger handpiece are constituted by spheres, ovoids or cylinders, arranged as a honeycomb, made as a gel with hardness comprised between 5 shore and 100 shore.

3. Device for the non-invasive personalized treatment of skin blemishes and disturbances, according to claim 1, wherein said rotating elements of said cylinder integrated in said of said smaller handpiece are constituted by spheres, ovoids or cylinders, arranged as a “V”, made of non-allergenic silicone with a surface treatment adapted to obtain a predetermined surface roughness, said rotating elements having hardness comprised between 5 shore and 100 shore.

4. Device for the non-invasive personalized treatment skin blemishes and disturbances, according to claim 1, wherein by means of said communication interface, the operator can independently adjust the rotation frequency and the vibration frequency of the cylinders of said handpieces.

5. Device for the non-invasive personalized treatment of skin blemishes and disturbances, according to claim 1, wherein each of said handpieces comprises:
a common quick release mechanism adapted to allow the stable disconnection and re-connection between a handpiece and the relative cylinder,
a pair of lateral indicators, placed on both sides of the relative handpiece, and adapted to emit light signals to the operator in order to indicate the drain direction for the purposes of a correct lymphatic drainage;
a light signaler constituted by a plurality of LED lights adapted to be progressively turned on with the increase of the pressure exerted by the operator on the body of the patient and vice versa; and
a display adapted to replicate said communication interface on the side of the handpiece viewed by the operator.

6. Device for the non-invasive personalized treatment of skin blemishes and disturbances, according to claim 1, wherein that said cylinder of said smaller handpiece is provided with a ring nut which, by rotating around the longitudinal axis of said cylinder, is adapted to modify the incidence angle of said rotating elements on the body of the patient, i.e. to ensure that they impart a converging or diverging force with respect to a neutral point corresponding with the position of said ring nut.

7. Device for the non-invasive personalized treatment of skin blemishes and disturbances, according to claim 1, wherein said rotating elements of said larger handpiece and/or of said smaller handpiece have an external surface provided with a plurality of recesses with spherical cap shape, adapted to create a suction effect when pressed on the epidermis of the patient.

8. Device for the non-invasive personalized treatment of skin blemishes and disturbances, according to claim 1, wherein said recesses of said console are provided with an internal heating element adapted to heat said handpieces when they are placed back into relative recesses up to a pre-established temperature by means of said communication interface.

9. Device for the non-invasive personalized treatment of skin blemishes and disturbances, according to claim 1, wherein said handpieces are provided with an internal heating element adapted to raise the temperature thereof, when not used, up to a pre-established temperature settable by means of said communication interface; said internal heating element, operating with infrared light, also has bactericide function.

10. Device for the non-invasive personalized treatment of skin blemishes and disturbances, according to claim 1, wherein at least one of said handpieces is provided with at least one temperature sensor adapted to detect the skin temperature of the patient, sending the data to said control unit which reproduces the data on said communication interface, also signaling the value of the temperature increase from the start of the treatment.

11. Method for the non-invasive personalized treatment of skin blemishes and disturbances, adapted for the diagnosis and treatment of skin blemishes and disturbances based on the characteristics of each patient, wherein it makes use of a treatment device according to claim 1, and comprises the following steps:
(A) first step of setting the parameters, in which an operator sets, by means of a communication interface of the treatment device, an admissible frequency range for the rotations and vibrations based on the characteristics of the tissue of the patient, on his/her age and his/her musculature; the frequency of the vibrations being comprised between 20 Hz and 700 Hz, preferably between 40 Hz and 355 Hz;
(B) second test step, in which, by grasping a handpiece of said treatment device, and placing the relative cylinder in contact with the body or with the face of the patient, an electrical energy absorption sensor of said handpiece-sends the detected data to a control unit-integrated in the treatment device; said control unit, comparing the electrical energy absorption data and the data of the vibration and rotation frequency set by the operator, communicates by means of the communication interface the correctness or lack of correctness of the vibration and rotation frequency range set by said operator;
(C) third step of administering the therapy, in which said operator follows the areas of the body or of the face of the patient to be treated with a handpiece, applying a predetermined pressure perpendicular to the skin tissue of the patient; during said third step of administration of the therapy, if the electrical energy absorption sensor of the handpiece during use detected a zone of greater mechanical strength, e.g. a muscular contracture, said control unit that processes the data sent by said electrical energy absorption sensor sends a command to increase the frequency of the vibrations and of the rotations to a frequency adjustment device of the frequency of the handpiece in use, up to detecting a lower mechanical strength;
(D) fourth step of monitoring the uniformity of the treatment over the entire area affected by the skin blemish or disturbance, said step able to be performed by means of visual analysis of the skin reddening due to the vascularization of the tissue induced by the treatment, by the operator, or
said step able to be performed by means of monitoring the increase of skin temperature, due to the vascularization of the tissue induced by the treatment, performed by the control unit which processes the temperature data detected by the temperature sensor of the handpiece in use.

12. The device of claim 2, wherein the hardness of the gel is 35 shore.

13. The device of claim 3, wherein the hardness of the rotating elements is 35 shore.
